(19) United States
(12) Patent Application Publication
(10) Pub. No.: US 2024/0263432 A1
(43) Pub. Date: Aug. 8, 2024

(54) SYSTEM AND METHOD FOR AUTOMATICALLY FLUSHING A TOILET BASED ON IMAGE RECOGNITION

(71) Applicant: William Bell, Orlando, FL (US)

(72) Inventor: William Bell, Orlando, FL (US)

(21) Appl. No.: 18/105,466

(22) Filed: Feb. 3, 2023

(51) Int. Cl. E03D 5/10; G06T 7/70; G06V 40/10

(52) U.S. Cl. CPC E03D 5/105; G06T 7/70; G06V 40/103; G06T 2207/20081; G06T 2207/30232

(57) ABSTRACT

A system and method for automatically flushing a toilet based on image recognition includes an image capture device having a camera, a wireless communication unit and a controller. The controller includes a machine learning model with a plurality of inferred positions corresponding to a cat defecating or urinating. The camera captures live images of a cat on a toilet, and the controller compares the live camera images to the inferred positions. Upon determining the cat is in one of the inferred positions for a predetermined period of time, a flush command is sent by the wireless communication unit. The system also includes a flush device having a linear actuator, a control switch and a controller. The shaft of the actuator is positioned adjacent to the toilet's flush handle or flush button and selectively depresses the same upon receipt of a flush command from the image device or the control switch.

### TECHNICAL FIELD

The present invention relates generally to image recognition systems, and more particularly to a system and method for flushing a toilet based upon image recognition.

### BACKGROUND

The statements in this section merely provide background information related to the present disclosure and may not constitute prior art.

It is not uncommon for households to have one or more domestic animals which remain indoors for the majority of the day. With specific regards to cats, many of these animals can be trained to utilize a toilet instead of a litter box. Such training is extremely beneficial for pet owners, as it removes the need to store an unsightly and often smelly litter box.

Unfortunately, many cats that are trained to use a toilet will only deposit their waste a single time and will refuse to do so again unless and until the toilet has been flushed. As such, even cats who are trained to use a toilet may still require a litter box to be readily available as there is no current way to flush the toilet after the animal is done. Although there are known self-flushing toilets on the market, such devices are motion based, and thus flush the toilet immediately upon detecting movement. Although useful for humans, such devices are not suitable for use with cats as the flushing action scares the animal away before they are able to start and/or complete their business.

Accordingly, it would be beneficial to provide a system that uses image recognition to detect the presence of a cat in a specific pose denoting it has completed its business before flushing the toilet. It would also be beneficial if the system was designed to work with a plurality of different toilets without having to change internal components or modify them.

### SUMMARY OF THE INVENTION

The present invention is directed to a system and method for automatically flushing a toilet based on image recognition. One embodiment of the present invention can include an image capture and recognition device having a camera, a wireless communication unit and a controller. The controller includes a machine learning model with a plurality of inferred positions corresponding to a cat defecating or urinating.

The camera functions to capture images of a cat on the toilet, and the controller includes functionality for comparing the live camera images to the inferred positions. Upon determining the cat is in the inferred position for a predetermined period of time, a flush command is sent by the wireless communication unit.

The system can also include a flush device having a main body that houses a linear actuator, a control switch, and a controller. The main body can be removably secured onto the toilet such that the shaft of the actuator is adjacent to the toilet's flush handle/flush button. Upon receiving the flush command from the image capture device or the onboard control switch, the actuator extends the shaft which depresses the flush handle/flush button to flush the toilet and remove the deposited waste.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a system and method for automatically flushing a toilet based on image recognition that is useful for understanding the inventive concepts disclosed herein.

FIG. 2 is a side view of the image capture and recognition device of the system in accordance with one embodiment of the invention.

FIG. 3 is a simplified block diagram of the system controller of the image capture and recognition device of the system, in accordance with one embodiment of the invention.

FIG. 4 is a perspective view of the flush device of the system, in accordance with one embodiment of the invention.

FIG. 5 is a simplified block diagram of the system controller of the flush device of the system, in accordance with one embodiment of the invention.

FIG. 6A is a perspective view of the flush device of the system in operation, in accordance with one embodiment of the invention.

FIG. 6B is another perspective view of the flush device of the system in operation, in accordance with one embodiment of the invention.

FIGS. 7A-7D are exemplary images captured by the camera and comparative data utilized by the image capture device of the system in operation, in accordance with one embodiment of the invention.

### DETAILED DESCRIPTION OF THE INVENTION

While the specification concludes with claims defining the features of the invention that are regarded as novel, it is believed that the invention will be better understood from consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described herein, the term “connector” includes any number of different elements that work alone or together to repeatedly join two items together in a nonpermanent manner. Several nonlimiting examples of connectors include, but are not limited to, flexible strips of interlocking projections with a slider (i.e., zipper), thread-to-connect, twist-to-connect, and push-to-connect type devices, opposing strips of hook and loop material (e.g., Velcro®), attractively oriented magnetic elements or magnetic and metallic elements, buckles such as side release buckles, clamps, sockets, clips, carabiners, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

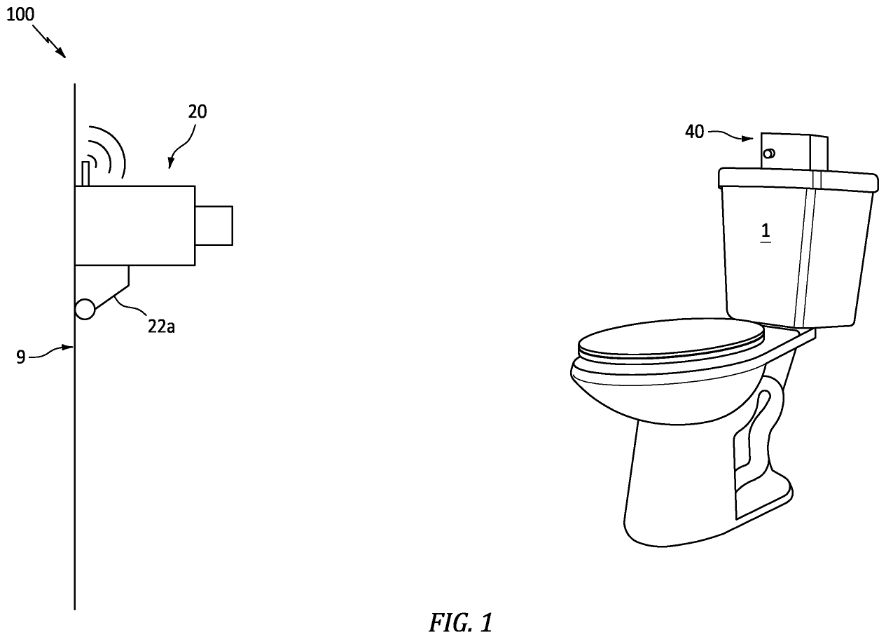

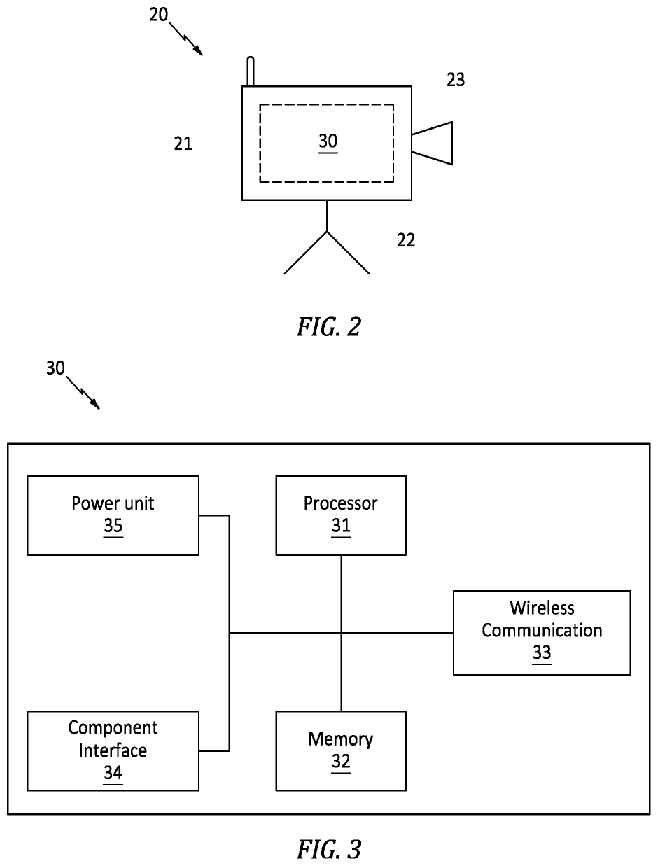

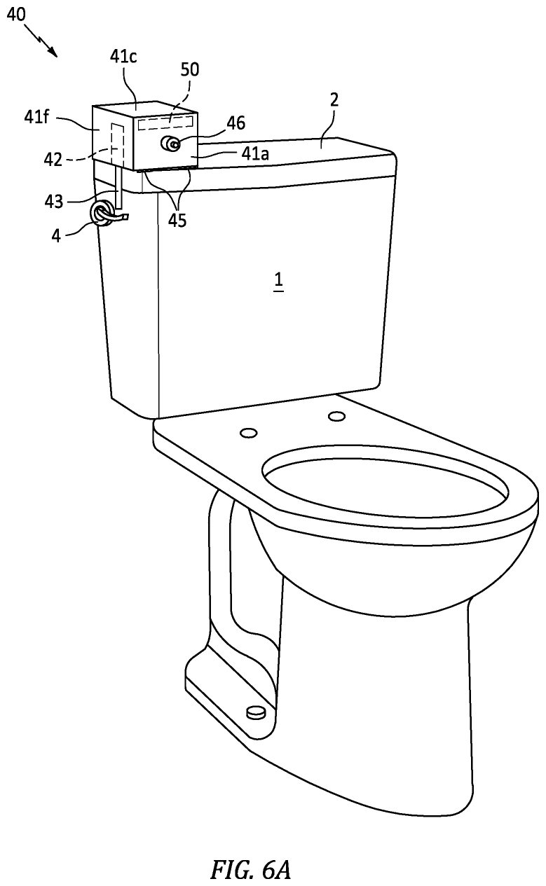

FIGS. 1-7D illustrate various embodiments of a system and method for flushing a toilet based upon image recognition 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in the drawings, one embodiment of system 100 can include an image capture and recognition device 20 and a toilet flush device 40.

The image capture and recognition device 20 can function to send a flush command to the flush device 40 upon detecting the presence of a cat in a specific position for a specific period of time. In one embodiment, device 20 can include a main body 21, an aiming device 22, a camera 23 and a controller 30.

The main body 21 can include any number of different shapes and sizes and can be constructed from any number of different materials such as various metals or plastics, for example, so as to securely position the device components. The aiming device can function to secure the main body 21 onto a vertical or horizontal surface such as a wall 9 or shelf, for example, so as to aim the camera 23 toward the toilet 1 to which the flushing device 40 is installed. Several nonlimiting examples of suitable aiming devices include the illustrated tripod 22, wall bracket 22a or other connectors, for example.

The camera 23 can include any type of image capture device capable of recording still or moving images in any one of the visible, near-infrared, or any appropriate spectrum, and may utilize a CCD (charge-coupled device) or CMOS (complementary metal-oxide semiconductor) imaging sensors, for example. Additionally, the camera may include or incorporate any number of known focusing lenses including a short or wide field-of-view lens to capture images that are proximately located near the device. Images captured by the camera 23 can be stored within the below described memory 32.

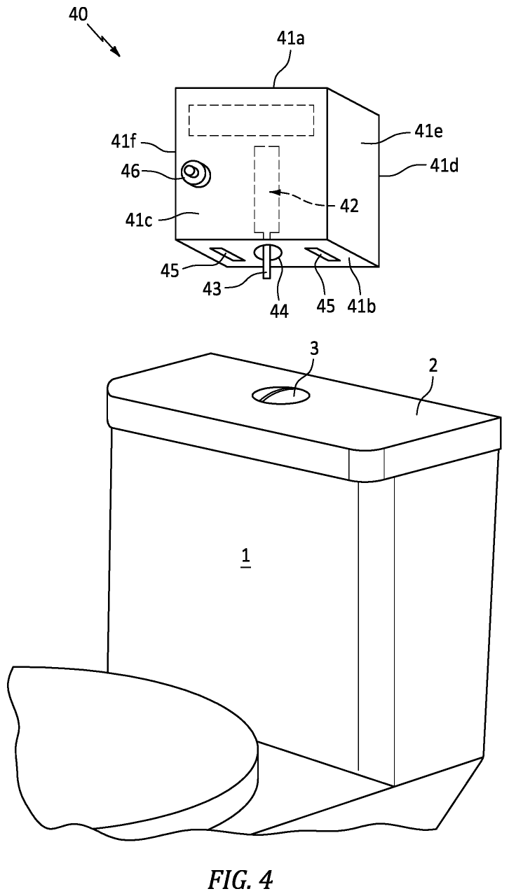

FIG. 3 illustrates one embodiment of the image device controller 30. As shown, the controller can include a processor 31 that is conventionally connected to an internal memory 32, a communication unit 33, a component interface unit 34 and/or a power source 35.

Although illustrated as separate elements, those of skill in the art will recognize that one or more system components may comprise or include one or more printed circuit boards (PCB) containing any number of integrated circuit or circuits for completing the activities described herein. Of course, any number of other analog and/or digital components capable of performing the below described functionality can be provided in place of, or in conjunction with the below described control system elements.

Additionally, although illustrated as being integrated within the main body of the device, other embodiments are contemplated wherein the device controller 30 comprises a discrete computing system that is communicatively linked to the camera 23 by a cable or in a wireless manner.

The processing unit 31 can be a conventional central processing unit (CPU) or any other type of device, or multiple devices, capable of manipulating or processing information such as program code stored in the memory 32 and for causing the circuitry to complete the activities and functionality described herein.

In one embodiment, a timer module can be provided and can function to accurately measure the passage of time. As described herein, the timer module can be provided as a function of the processor or can include a separate physical circuit.

The Memory 32 can act to store operating instructions in the form of program code for the processor 31 to execute. Although illustrated in FIG. 3 as a single component, memory 32 can include one or more physical memory devices such as, for example, local memory and/or one or more bulk storage devices. To this end, the memory can be loaded with images of cats in specific positions and can receive and store audiovisual information from the camera 23, in order to allow the device to perform optical/image recognition as will be described below.

The Communication unit 33 can include any number of components capable of sending and/or receiving electronic signals with an externally located device, either directly or over a network. In one embodiment, the communication unit can include a Bluetooth transceiver for communicating wirelessly with the communication unit 43 of the flushing device 40.

Of course, the communication unit is not limited to the use of a Bluetooth transceiver, as any number of other known transmission and/or reception devices and protocols can also be utilized herein, several nonlimiting examples include Wi-Fi transceivers, Near-Field-Communication (NFC) devices, radio systems and network adapters that can communicate over a wireless network such as a home network, a WAN, LAN or the internet via an internet service provider, for example.

The component interface unit 34 can function to provide a communicative link between the processor 31 and various other device components such as the camera 23, for example. In this regard, the component interface unit can include any number of different components such as one or more PIC microcontrollers, internal bus, USB connections and other such hardware capable of providing a direct link between the various components. Of course, any other means for providing two-way communication between various system components can also be utilized herein.

Power unit 35 can preferably include an A/C electrical power transformer and cord, or other such components capable of allowing the device to be powered from a standard electrical outlet. Of course, other embodiments are also contemplated wherein the power source can include one or more batteries.

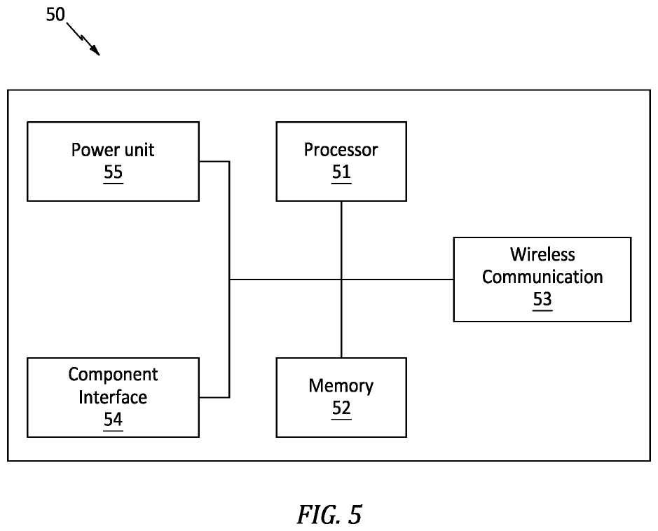

The flush device 40 is designed to be positioned onto a toilet and to selectively flush the toilet upon receiving a signal from the image capture and recognition device 20. As shown best at FIG. 4, the flush device 40 can include a main body having a top surface 41a, a bottom surface 41b, a front surface 41c, a back surface 41d and a pair of side surfaces 41e and 41f that define an interior space.

The main body can include any number of different shapes and sizes, and may be formed from materials that are, for example, relatively strong and stiff for their weight. Several nonlimiting examples include but are not limited to various metals or metal alloys (e.g., aluminum, steel, titanium, or alloys thereof), plastic/polymers (e.g., high-density polyethylene (HDPE), rigid polyvinyl chloride (PVC), malleable polyethylene terephthalate (PET)), and/or various composite materials (e.g., carbon fibers in a polymer matrix, fiberglass, etc.,).

In one embodiment, a linear actuator 42 can be positioned within or along the main body. The linear actuator can be connected to and controlled by the below described controller 50 and can include a main body having an elongated linear shaft 43 that selectively extends from and retracts within an opening 44 in the main body. Although described as a linear actuator, those of skill in the art will recognize that any number of other devices capable of selectively extending and retracting a rod are suitable for use herein.

In one embodiment, one or more connectors 45 such as elongated strips of hook and loop material, for example, can be positioned along the bottom wall of the main body. The connector(s) can function to secure the main body onto the lid 2 of the toilet such that the distal end of the shaft 43 is located above the flush button/lever 3 of the toilet. As will be described below, when the shaft 43 is in the extended position, the distal end will depress the flush button causing the toilet to flush.

In one embodiment, a control switch 46 can be positioned along the main body. The control switch can be connected to the controller 50 and/or the linear actuator so as to allow a user to manually flush the toilet when desired.

In one embodiment, the flush device 40 can include a controller 50 having a processor 51 that is conventionally connected to an internal memory 52, a communication unit 53, a component interface unit 54 and/or a power source 55. As described herein, components 51-55 can be identical or substantially identical to the above-described components 31-35, respectively, such that a duplicate description is not needed.

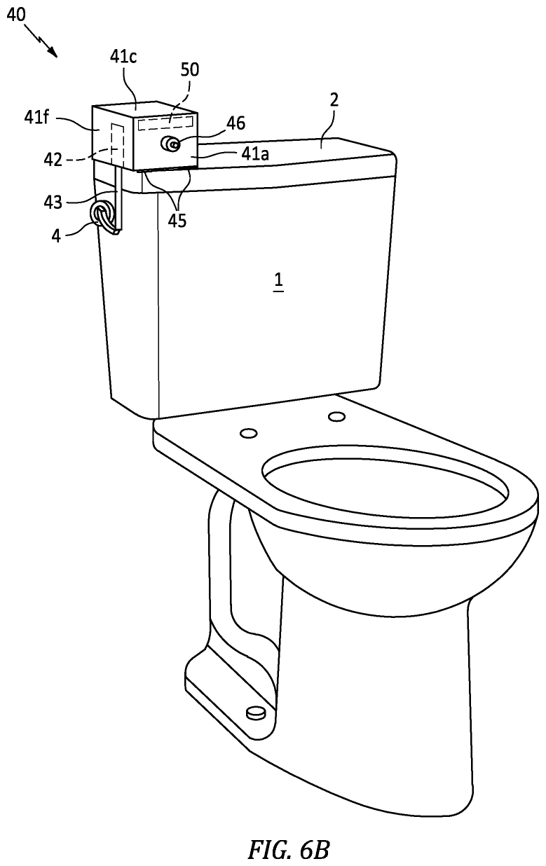

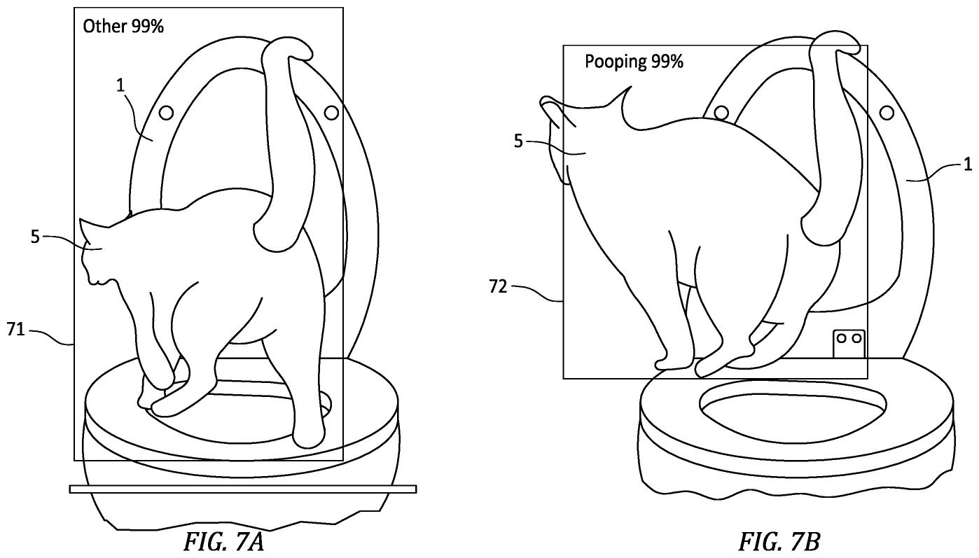

Although illustrated above in use with a toilet 1 having a flush button 3 on the lid 2 this is but one possible implementation of the flush device 40. To this end, FIGS. 6A and 6B illustrates one embodiment of the flush device 40 wherein the linear actuator 42 is positioned along or adjacent to one side- e.g., 41f—of the main body such that the shaft 43 extends below the bottom wall 41a in the retracted position. In such a configuration, the distal end of the shaft can be aligned with the top portion of a tank mounted flush handle 4, and when the shaft is extended, can push the handle 4 downward in order to flush the toilet.

In operation, the controller of the image capture and recognition device 20 can include a program comprising a machine learning model that has been pre-trained to detect cats in several distinct positions (e.g., inferred positions). These positions can include a defecating position common to all cats when defecating, a urinating position (male and female) that is common to all cats when urinating, and an “other” position wherein the cat is not in either of the urinating or defecating positions.

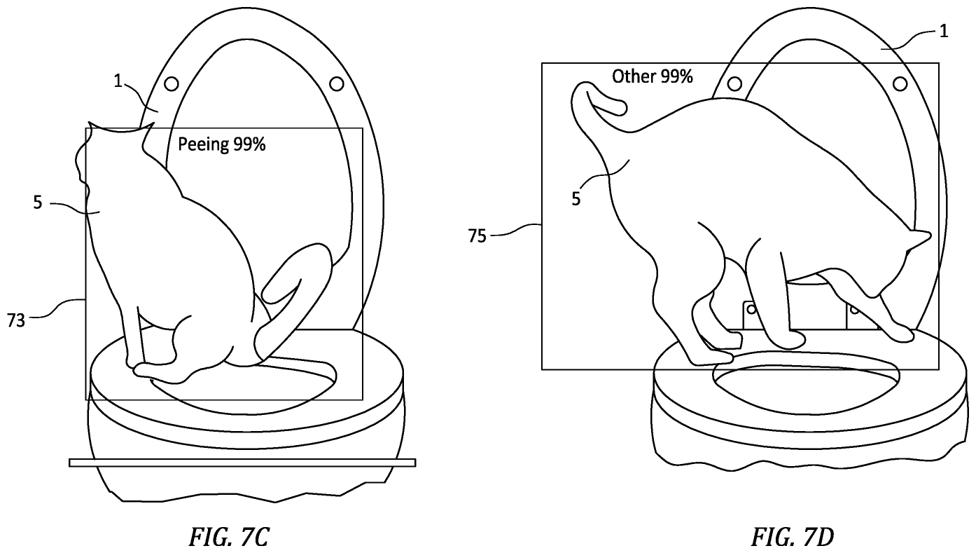

As shown, at FIG. 7A, the camera can function to continuously monitor the toilet and can detect the presence of a cat 5 on the toilet seat. Once the cat is detected, the device 20 can continuously compare the position of the cat 71 with the inferred positions.

As shown at FIGS. 7B-7C, upon detecting that the cat is in one of the inferred positions 72 or 73, respectively, the system can utilize a frame count 74 or timer to ensure the cat remains in the position for a set period of time e.g., 20 seconds or 600 frames (20 seconds at 30 frames per second), for example.

As shown at FIG. 7D, upon determining that the cat remained in the set position for the required time or frames, and that the cat is no longer in the set position 75, the wireless communication unit 33 of the image device 20 can send a flush command to the wireless communication unit 35 of the flush device 40.

Upon receiving the flush command from device 20, or upon receiving a command directly from the onboard control switch 46, the controller 50 can activate the linear actuator 42 so as to extend the shaft 43 and flush the toilet as described above.

Although described and illustrated with regard to a cat using a conventional toilet, those of skill in the art will recognize that the inventive concepts can be utilized for any type of animal while utilizing any type of device.

As to a further description of the manner and use of the present invention, the same should be apparent from the above description. Accordingly, no further discussion relating to the manner of usage and operation will be provided.

As described herein, one or more elements of device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system, comprising:
an image capture device having a camera and a controller; and
a flushing device having a main body and an actuator,
wherein the image capture device is configured to detect the presence of an animal on a toilet and to selectively send a flush command to the flushing device, and
wherein the flushing device is configured to flush the toilet upon receipt of the flush command.

2. The system of claim 1, further comprising:
at least one connector that is positioned along the main body of the flushing device, said connector functioning to removably secure the main body onto a lid of the toilet.

3. The system of claim 2, wherein the actuator includes an elongated shaft having a distal end that is configured to engage at least one of a flush button or a flush handle on the toilet.

4. The system of claim 3, wherein the actuator is configured to selectively extend and retract the elongated shaft.

5. The system of claim 4, wherein in the retracted position, the shaft is positioned above at least one flush button or flush handle.

6. The system of claim 4, wherein in the extended position, the shaft is positioned against and imparts a force onto the at least one flush button or flush handle.

7. The system of claim 6, wherein the force is sufficient to cause at least one flush button or flush handle to flush the toilet.

8. The system of claim 1, further comprising:
an aiming device that is connected to the image capture device.

9. The system of claim 8, wherein the aiming device includes at least one of a tripod or a wall bracket.

10. The system of claim 1, wherein the controller of the image capture device includes a memory.
